(19) United States
(12) Patent Application Publication
(10) Pub. No.: US 2016/0237313 A1
(43) Pub. Date: Aug. 18, 2016

(54) Methods of Making Rosin Esters

(71) Applicant: ARIZONA CHEMICAL COMPANY, LLC, Jacksonville, FL (US)

(72) Inventors: Paul A. Williams, Savannah, GA (US); Lloyd A. Nelson, Savannah, GA (US); Rachel C. Severance, Savannah, GA (US)

(73) Assignee: Arizona Chemical Company, LLC, Jacksonville, FL (US)

(21) Appl. No.: 15/025,099

(22) PCT Filed: Sep. 26, 2014
(86) PCT No.: PCT/US14/57691

§ 371 Date: Mar. 25, 2016

Related U.S. Application Data
(60) Provisional application No. 61/883,793, filed on Sep. 27, 2013.

(51) Int. Cl. C09F 1/02; C09F 1/04

(52) U.S. Cl. CPC C09F 1/02; C09F 1/04

(57) ABSTRACT

Provided herein are methods of making rosin esters. The methods can involve contacting a rosin ester with a microporous adsorbent. Treatment with a microporous adsorbent, such as an activated carbon, can improve the color of the rosin ester (e.g., reduce the neat Gardner color of the rosin ester by at least 1 Gardner color unit), reduce the concentration of sulfur in the rosin ester (e.g., reduce the concentration of sulfur in the rosin ester by at least 50 ppm), or combinations thereof. Rosin esters prepared by the methods described herein, as well as methods of using thereof, are also described.

### TECHNICAL FIELD

This application relates generally to methods of making rosin esters.

### BACKGROUND

Rosin esters, including rosin esters derived from polyhydric alcohols, have been known for more than 50 years. See, for example, U.S. Pat. No. 1,820,265 to Bent, et al. Rosin esters are typically formed by the reaction of rosin, which is primarily a mixture of isomeric C₂₀ tricyclic mono-carboxylic acids known as rosin acids, with alcohols such as glycerol or pentaerythritol. The resultant rosin esters serve as additives in a variety of applications, including as tackifiers in hot-melt and pressure-sensitive adhesives, modifiers for rubbers and various plastics, emulsifiers for synthetic rubbers, base materials for chewing gum, resins in coating compositions such as traffic paints and inks, and sizing agents for paper making.

While suitable for many applications, many existing rosin esters fail to possess suitable properties for particular applications. Notably, many commercially available rosin esters are colored (e.g., yellow or yellowish brown) and/or have an unacceptably high sulfur content. Accordingly, there continues to be a need for rosin esters which exhibit improved color (e.g., are colorless or nearly colorless) and decreased sulfur content.

### SUMMARY

Provided herein are methods of making rosin esters. The methods can involve contacting a rosin ester with a microporous adsorbent, such as activated carbon. The microporous adsorbent can have a surface area ranging from 500 m²/g to 2000 m²/g. Treatment with a microporous adsorbent can improve the color of the rosin ester (e.g., reduce the neat Gardner color of the rosin ester by at least 1 Gardner color unit), reduce the concentration of sulfur in the rosin ester (e.g., reduce the concentration of sulfur in the rosin ester by at least 50 ppm), or combinations thereof.

In some embodiments, the method of making a rosin ester can comprise (a) esterifying a rosin with an alcohol to form a rosin ester; and (b) flowing the rosin ester through a microporous adsorbent having 500 m²/g to 2000 m²/g. Methods can further comprise hydrogenating the rosin ester to form a hydrogenated rosin ester, disproportionating the rosin prior to the esterification reaction, or combinations thereof.

Esterification step (a) can comprise contacting a rosin with a suitable alcohol and optionally an esterification catalyst, and allowing the rosin and the alcohol to react for a period of time and under suitable conditions to form the crude rosin ester. The rosin can comprise tall oil rosin, gum rosin, wood rosin, or mixtures thereof. In certain embodiments, the rosin comprises tall oil rosin. In certain embodiments, the alcohol comprises a polyhydric alcohol. The polyhydric alcohol can be selected from the group consisting of ethylene glycol, propylene glycol, diethylene glycol, triethylene glycol, tetraethylene glycol, trimethylene glycol, glycerol, trimethylolpropane, trimethylolethane, pentaerythritol, mannitol, and combinations thereof.

The rosin ester can subsequently be flowed through a microporous adsorbent. The microporous adsorbent can include activated carbon, metal oxides, such as alumina, zirconia, and silica, macroreticular ion exchange resins, zeolites, microporous clays, or combinations thereof. In certain cases, the microporous adsorbent comprises a volume of micropores ranging from 0.05 mL/g to 0.4 mL/g, a volume of mesopores ranging from 0.1 mL/g to 1.25 mL/g, a volume of macropores ranging from 0.1 mL/g to 0.7 mL/g, or combinations thereof. In certain embodiments, the microporous adsorbent comprises an activated carbon, such as a granular activated carbon (GAC).

In some embodiments, the rosin ester is flowed through a stationary phase comprising the microporous adsorbent. The stationary phase can be disposed within any suitable vessel, such as a fixed bed reactor, so as to facilitate treatment of the rosin ester with the microporous adsorbent. The flow rate of the rosin ester, volume of the microporous adsorbent, and/or composition of the microporous adsorbent can be selected to provide a rosin ester having the desired physical and chemical properties for a particular application. For example, the rosin ester can be flowed through the microporous adsorbent at a flow rate effective to reduce the neat Gardner color of the rosin ester by at least 10%. In some embodiments, the rosin ester can be flowed through the microporous adsorbent at a flow rate effective to reduce the neat Gardner color of the rosin ester, as determined according to the method described in ASTM D1544-04 (2010), by at least 1 Gardner color unit (e.g., to reduce the neat Gardner color of the rosin ester by from 1 to 2.5 Gardner color units). In some embodiments, the rosin ester is flowed through the microporous adsorbent at a flow rate effective to reduce the concentration of sulfur in the rosin ester by at least 10%. In some embodiments, the volume of the microporous adsorbent and the flow rate of the rosin ester through the microporous adsorbent are selected to provide an empty bed contact time of at least 1.5 hours.

Also provided are methods of making rosin esters which can comprise (a) flowing a rosin through a microporous adsorbent; and (b) esterifying the rosin with an alcohol to form the rosin ester. These methods can further comprise hydrogenating the rosin ester to form a hydrogenated rosin ester, disproportionating the rosin prior to treatment of the rosin with the microporous adsorbent (e.g., activated carbon),i.e., prior to step (a), or combinations thereof.

Rosin esters prepared by the methods described herein, as well as methods of using thereof, are also described.

### DETAILED DESCRIPTION

Provided herein are methods of making rosin esters. The methods can involve contacting a rosin ester with a microporous adsorbent, such as activated carbon. The microporous adsorbent can have a surface area ranging from 500 m²/g to 2000 m²/g. Treatment with a microporous adsorbent can reduce the color of the rosin ester (e.g., reduce the neat Gardner color of the rosin ester by at least 1 Gardner color unit), reduce the concentration of sulfur in the rosin ester (e.g., reduce the concentration of sulfur in the rosin ester by at least 50 ppm), or combinations thereof.

The rosin ester can be contacted with the microporous adsorbent in any suitable fashion. For example, the rosin ester and the microporous adsorbent can be combined to form a slurry. The microporous adsorbent can be present in the slurry in amount ranging from 0.01% by weight to 15% by weight, based on the weight of the rosin ester present in the slurry. In certain embodiments, the microporous adsorbent can be present in the slurry in amount ranging from 0.1% by weight to 5% by weight, based on the weight of the rosin ester present in the slurry. In some cases, the slurry can comprise at least 75% by weight rosin ester, based on the total weight of the slurry (e.g., at least 80% by weight rosin ester, at least 85% by weight rosin ester, or at least 90% by weight rosin ester). In certain embodiments, the slurry is substantially free of solvent (i.e., the slurry contains less than 1% by weight solvent, based on the total weight of the slurry). Contacting the rosin ester with the microporous adsorbent can also comprise flowing the rosin ester through a microporous adsorbent, as discussed in more detail below. The rosin ester and the microporous adsorbentcan be contacted under suitable conditions (e.g., elevated temperature) and for a period of time effective to reduce the Gardner color of the rosin ester (e.g., reduce the neat Gardner color of the rosin ester by at least 1 Gardner color unit), reduce the concentration of sulfur in the rosin ester (e.g., reduce the concentration of sulfur in the rosin ester by at least 50 ppm), or combinations thereof.

In some embodiments, the method of making a rosin ester can comprise (a) esterifying a rosin with an alcohol to form a rosin ester; and (b) flowing the rosin ester through a microporous adsorbent. The microporous adsorbent can have a surface area ranging from 500 m²/g to 2000 m²/g. Methods can further comprise hydrogenating the rosin ester to form a hydrogenated rosin ester, disproportionating the rosin prior to the esterification reaction, or combinations thereof.

Esterification step (a) can comprise contacting a rosin with a suitable alcohol, and allowing the rosin and the alcohol to react for a period of time and under suitable conditions to form the crude rosin ester. Suitable reaction conditions for esterifying rosin are known in the art. See, for example, U.S. Pat. No. 5,504,152 to Douglas et al., which is hereby incorporated by reference in its entirety. Suitable reaction conditions can be selected in view of a number of factors, including the nature of the reactants (e.g., the chemical and physical properties of the rosin, the identity of the alcohol, etc.) and the desired chemical and physical properties of the resultant rosin ester. For example, rosin can be esterified by a thermal reaction of the rosin with an alcohol. Esterification can comprise contacting the rosin with the alcohol at an elevated temperature (e.g., at a temperature from greater than greater than 30° C. to 250° C.). In some embodiments, esterification step (a) can involve contacting molten rosin with an alcohol and optionally an esterification catalyst for a period of time suitable to form the rosin ester. In some cases, the esterification reaction involves contacting the rosin with an alcohol and optionally an esterification catalyst for a period of time effective to provide a rosin ester having an acid number of 15 or less.

Any suitable rosin can be used in the esterification reaction. Rosin, also called colophony or Greek pitch (Pix graæca), is a solid hydrocarbon secretion of plants, typically of conifers such as pines (e.g., Pinus palustris and Pinus caribaea). Rosin can include a mixture of rosin acids, with the precise composition of the rosin varying depending in part on the plant species. Rosin acids are C₂₀ fused-ring monocarboxylic acids with a nucleus of three fused six-carbon rings containing double bonds that vary in number and location. Examples of rosin acids include abietic acid, neoabietic acid, dehydroabietic acid, dihydroabietic acid, pimaric acid, levopimaric acid, sandaracopimaric acid, isopimaric acid, and palustric acid. Natural rosin typically consists of a mixture of seven or eight rosin acids, in combination with minor amounts of other components.

Rosin is commercially available, and can be obtained from pine trees by distillation of oleoresin (gum rosin being the residue of distillation), by extraction of pine stumps (wood rosin) or by fractionation of tall oil (tall oil rosin). Any type of rosin can be used in the esterification reaction, including tall oil rosin, gum rosin, wood rosin, and mixtures thereof. In certain embodiments, the rosin comprises tall oil rosin. Rosins can be used as a feedstock for the formation of rosin esters as obtained from a commercial or natural source. Examples of commercially available rosins include tall oil rosins such as SYLVAROS® 90 and SYLVAROS® NCY, commercially available from Arizona Chemical. Alternatively, rosin can be subjected to one or more purification steps (e.g., distillation under reduced pressure, extraction, and/or crystallization) prior to its use as a feedstock for the formation of rosin esters.

Any suitable alcohol, include monoalcohols, diols, and other polyols, can be used in esterification reaction. Examples of suitable alcohols include glycerol, pentaerythritol, dipentaerythritol, ethylene glycol, diethylene glycol, triethylene glycol, sorbitol, neopentylglycol, trimethylolpropane, methanol, ethanol, propanol, butanol, amyl alcohol, 2-ethyl hexanol, diglycerol, tripentaerythritol, C₈-C₁₁ branched or unbranched alkyl alcohols, and C₇-C₁₆ branched or unbranched arylalkylalcohols. In certain embodiments, the alcohol is a polyhydric alcohol. For example, the polyhydric alcohol can be selected from the group consisting of ethylene glycol, propylene glycol, diethylene glycol, triethylene glycol, tetraethylene glycol, trimethylene glycol, glycerol, trimethylolpropane, trimethylolethane, pentaerythritol, dipentaerythritol, mannitol, and combinations thereof. In some embodiments, more than one alcohol is used in the esterification reaction. In certain embodiments, pentaerythritol and one or more additional alcohols selected from the group consisting of glycerol, dipentaerythritol, ethylene glycol, diethylene glycol, triethylene glycol, trimethylolpropane, and combinations thereof are used in esterification reaction.

The amount of alcohol employed in esterification reaction relative to the amount of rosin can be varied, depending on the nature of the alcohol and the desired chemical and physical properties of the resultant rosin ester. In some embodiments, the rosin is provided in excess so as to produce a resultant rosin ester having a low hydroxyl number. For example, the alcohol can be provided in an amount such that less than a molar equivalent of hydroxy groups is present in the reaction relative to the amount of rosin present. In other embodiments, the alcohol is provided in excess so as to produce a resultant rosin ester having a low acid number.

As is known in the art, catalysts, solvents, bleaching agents, stabilizers, and/or antioxidants can be added to the esterification reaction. Suitable catalysts, solvents, bleaching agents, stabilizers, and antioxidants are known in the art, and described, for example, in U.S. Pat. Nos. 2,729,660, 3,310,575, 3,423,389, 3,780,013, 4,172,070, 4,548,746, 4,690,783, 4,693,847, 4,725,384, 4,744,925, 4,788,009, 5,021,548, and 5,049,652. In some embodiments, the esterification reaction involves contacting the rosin with the alcohol in the presence of an esterification catalyst. Suitable esterification catalysts are known in the art, and include Lewis and Brønsted-Lowry acids. Examples of suitable esterification catalysts include acidic catalysts such as acetic acid, p-touluenesulfonic acid, and sulfuric acid; alkaline metal hydroxides such as calcium hydroxide; metal oxides, such as calcium oxide, magnesium oxide, and aluminum oxide; and other metal salts, such as iron chloride, calcium formate, and calcium phosphonates (e.g., calcium bis-monoethyl(3,5-di-tert-butyl-4-hydroxybenzyl) phosphonate, Irganox® 1425).

The esterification reaction can also comprise contacting the rosin with the alcohol in the presence of activated carbon. In some embodiments, the esterification reaction can comprise contacting the rosin with the alcohol in the presence of activated carbon, and in the absence of an additional esterification catalyst. Suitable activated carbons are commercially available, for example, under the trade name NORIT® from Cabot Norit Americas, Inc. In order to drive the esterification reaction to completion, water can be removed from the reactor using standard methods, such as distillation and/or application of a vacuum.

The rosin ester can subsequently be flowed through a microporous adsorbent. The rosin ester can optionally include a solvent to facilitate flow through the microporous adsorbent. In some embodiments, the rosin ester comprises little or substantially no solvent. For example, in some embodiments, the rosin ester comprises less than 25% by weight solvent, based on the total weight of the rosin ester (e.g., less than 20% by weight, less than 15% by weight, less than 10% by weight, or less than 5% by weight). In some embodiments, the concentration of esterified rosin acids in the rosin ester flowed through the microporous adsorbent is 75% or more by weight, based on the total weight of the rosin ester (i.e., at least 80% by weight esterified rosin acids, at least 85% by weight esterified rosin acids, or at least 90% by weight esterified rosin acids). In some embodiments, the rosin ester flowed through the microporous adsorbent is substantially free of solvent (e.g., the rosin ester comprises less than 1% by weight solvent, based on the total weight of the rosin ester). In certain embodiments, the rosin ester flowed through the microporous adsorbent has a viscosity of 1,000 cP or less at 25° C.

The rosin ester can be flowed through the microporous adsorbent at an elevated temperature. In some embodiments, the rosin ester can be flowed through the microporous adsorbent at a temperature of at least 150° C. (e.g., at least 160° C., at least 170° C., at least 180° C., at least 190° C., at least 200° C., at least 210° C., at least 220° C., at least 230° C., at least 240° C., at least 250° C., at least 260° C., or at least 270° C.). In some embodiments, the rosin ester can be flowed through the microporous adsorbent at a temperature of 280° C. or less (e.g., 270° C. or less, 260° C. or less, 250° C. or less, 240° C. or less, 230° C. or less, 220° C. or less, 210° C. or less, 200° C. or less, 190° C. or less, 180° C. or less, 170° C. or less, or 160° C. or less).

The rosin ester can be flowed through the microporous adsorbent at a temperature ranging from any of the minimum values described above to any of the maximum values described above. For example, The rosin ester can be flowed through the microporous adsorbent at a temperature ranging from 150° C. to 280° C. (e.g., from 180° C. to 240° C., or from 200° C. to 220° C.).

In certain embodiments, the rosin ester can be flowed through the microporous adsorbent, such as an activated carbon, at a temperature ranging from 240° C. to 280° C. At these temperatures, the rosin ester can be disproportionated while being flowed through the microporous adsorbent. In some embodiments, the rosin ester can be flowed through the microporous adsorbent (e.g., activated carbon) at a temperature ranging from 240° C. to 280° C. at a flow rate effective to induce from 5% to 20% disproportionation by weight, based on the total weight of the rosin ester (e.g., from 6% to 15% disproportionation by weight, or from 6% to 10% disproportionation by weight).

The microporous adsorbent can be any suitable microporous material which can function as an adsorbent, and thereby reduce the color of the rosin ester, the concentration of sulfur in the rosin ester, or combinations thereof. A variety of microporous adsorbents are known in the art, and include activated carbon, metal oxides, such as alumina, zirconia, and silica, macroreticular ion exchange resins, zeolites, and microporous clays.

The microporous adsorbent can have a high surface area. In some embodiments, the microporous adsorbent has a surface area of greater than 500 m²/g (e.g., greater than 600 m²/g, greater than 700 m²/g, greater than 800 m²/g, greater than 900 m²/g, greater than 1000 m²/g, greater than 1100 m²/g, greater than 1200 m²/g, greater than 1300 m²/g, greater than 1400 m²/g, greater than 1500 m²/g, greater than 1600 m²/g, greater than 1700 m²/g, greater than 1800 m²/g, or greater than 1900 m²/g). In some embodiments, the microporous adsorbent has a surface area of 2000 m²/g or less (e.g., 1900 m²/g or less, 1850 m²/g or less, 1800 m²/g or less, 1750 m²/g or less, 1700 m²/g or less, 1650 m²/g or less, 1600 m²/g or less, 1550 m²/g or less, 1500 m²/g or less, 1450 m²/g or less, 1400 m²/g or less, 1350 m²/g or less, 1300 m²/g or less, 1250 m²/g or less, 1200 m²/g or less, 1150 m²/g or less, 1100 m²/g or less, 1050 m²/g or less, 1000 m²/g or less, 950 m²/g or less, 900 m²/g or less, 850 m²/g or less, 800 m²/g or less, 750 m²/g or less, 700 m²/g or less, 650 m²/g or less, 600 m²/g or less, or 550 m²/g or less).

The microporous adsorbent can have a surface area ranging from any of the minimum values described above to any of the maximum values described above. For example, the microporous adsorbent can have a surface area ranging from 500 m²/g to 2000 m²/g (e.g., from 750 m²/g to 2000 m²/g, from 1000 m²/g to 2000 m²/g, from 1000 m²/g to 1750 m²/g, or from 1000 m²/g to 1500 m²/g).

The microporous adsorbent can have varying porosity. The microporous adsorbent can include micropores (pores having a diameter <2 nm), mesopores (pores having a diameter of from 2 to 50 nm), macropores (pores having a diameter of >50 nm), or combinations thereof. The porosity of the microporous adsorbent can be characterized in terms of volume of micropores, mesopores, macropores, or combinations thereof present in the material.

In some embodiments, the microporous adsorbent comprises at least 0.05 mL/g of micropores (e.g., at least 0.1 mL/g, at least 0.15 mL/g, at least 0.2 mL/g, at least 0.25 mL/g, at least 0.3 mL/g, or at least 0.35 mL/g). In some embodiments, the microporous adsorbent comprises 0.4 mL/g of micropores or less (e.g., 0.35 mL/g or less, 0.3 mL/g or less, 0.25 mL/g or less, 0.2 mL/g or less, 0.15 mL/g or less, or 0.1 mL/g or less). The microporous adsorbent can comprise a volume of micropores ranging from any of the minimum values above to any of the maximum values described above. For example, the microporous adsorbent can comprise a volume of micropores ranging from 0.05 mL/g to 0.4 mL/g (e.g., from 0.1 mL/g to 0.3 mL/g).

In some embodiments, the microporous adsorbent comprises at least 0.1 mL/g of mesopores (e.g., at least 0.15 mL/g, at least 0.2 mL/g, at least 0.25 mL/g, at least 0.3 mL/g, at least 0.35 mL/g, at least 0.4 mL/g, at least 0.45 mL/g, at least 0.5 mL/g, at least 0.55 mL/g, at least 0.6 mL/g, at least 0.65 mL/g, at least 0.7 mL/g, at least 0.75 mL/g, at least 0.8 mL/g, at least 0.85 mL/g, at least 0.9 mL/g, at least 0.95 mL/g, at least 1.0 mL/g, at least 1.05 mL/g, at least 1.10 mL/g, at least 1.15 mL/g, or at least 1.20 mL/g). In some embodiments, the microporous adsorbent comprises 1.25 mL/g of mesopores or less (e.g., 1.20 mL/g or less, 1.15 mL/g or less, 1.10 mL/g or less, 1.05 mL/g or less, 1.0 mL/g or less, 0.95 mL/g or less, 0.9 mL/g or less, 0.85 mL/g or less, 0.8 mL/g or less, 0.75 mL/g or less, 0.7 mL/g or less, 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, or 0.15 mL/g or less). The microporous adsorbent can comprise a volume of mesopores ranging from any of the minimum values above to any of the maximum values described above. For example, the microporous adsorbent can comprise a volume of mesopores ranging from 0.1 mL/g to 1.25 mL/g (e.g., 0.2 mL/g to 1.25 mL/g, 0.75 mL/g to 1.25 mL/g, from 0.1 mL/g to 1.0 mL/g, or from 0.2 mL/g to 0.9 mL/g).

In some embodiments, the microporous adsorbent comprises at least 0.1 mL/g of macropores (e.g., at least 0.15 mL/g, at least 0.2 mL/g, at least 0.25 mL/g, at least 0.3 mL/g, at least 0.35 mL/g, at least 0.4 mL/g, at least 0.45 mL/g, at least 0.5 mL/g, at least 0.55 mL/g, at least 0.6 mL/g, or at least 0.65 mL/g). In some embodiments, the microporous adsorbent comprises 0.7 mL/g of macropores or less (e.g., 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, or 0.15 mL/g or less). The microporous adsorbent can comprise a volume of macropores ranging from any of the minimum values above to any of the maximum values described above. For example, the microporous adsorbent can comprise a volume of macropores ranging from 0.1 mL/g to 0.7 mL/g (e.g., from 0.2 mL/g to 0.6 mL/g, or from 0.25 mL/g to 0.55 mL/g).

In some embodiments, the microporous adsorbent comprises a greater volume of micropores than volume of mesopores or volume of macropores. In other embodiments, the microporous adsorbent comprises a greater volume of mesopores than volume of micropores or volume of macropores. In other embodiments, the microporous adsorbent comprises a greater volume of macropores than volume of micropores or volume of mesopores.

In some cases, the ratio of the volume of micropores in the microporous adsorbent to the volume of mesopores in the microporous adsorbent ranges from 1:7.5 to 2:1. For example, the ratio of the volume of micropores in the microporous adsorbent to the volume of mesopores in the microporous adsorbent can be 1:5, 1:3.6, 1:2, or 1.5:1. In some cases, the ratio of the volume of mesopores in the microporous adsorbent to the volume of macropores in the microporous adsorbent ranges from 1:2 to 1:0.25. For example, the ratio of the volume of mesopores in the microporous adsorbent to the volume of macropores in the microporous adsorbent can be 1:1.25, 1:0.6, or 1:1. In some cases, the ratio of the volume of micropores in the microporous adsorbent to the volume of macropores in the microporous adsorbent ranges from 1:5 to 1:0.7. For example, the ratio of the volume of micropores in the microporous adsorbent to the volume of mesopores in the microporous adsorbent can be 1:3, 1:2.2, 1:2, or 1:0.83.

In certain embodiments, the microporous adsorbent comprises an activated carbon. Activated carbon is a micro-crystalline, non-graphitic form of carbon which has been processed to develop a large internal surface area and pore volume. These characteristics, along with other variables including surface area and functional groups which render the surface chemically reactive, can be selected, as required, to influence the activated carbon's adsorptivity.

Suitable activated carbons can be produced from various carbonaceous raw materials using methods known in the art, each of which impart particular qualities to the resultant activated carbon. For example, activated carbons can be prepared from lignite, coal, bones, wood, peat, paper mill waste (lignin), and other carbonaceous materials such as nutshells. Activated carbons can be formed from carbonaceous raw materials using a variety of methods known in the art, including physical activation (e.g., carbonization of the carbonaceous raw material followed by oxidation) and chemical activation.

A variety of forms of activated carbon can be used, including powdered activated carbon (PAC; a particulate form of activated carbon containing powders or fine granules of activated carbon less than 1.0 mm in size), granular activated carbon (GAC), extruded activated carbon (EAC; powdered activated carbon fused with a binder and extruded into a variety of shapes), bead activated carbon (BAC), and activated carbon fibers. Suitable forms of activated carbon can be selected in view of their desired level of catalytic activity as well as process considerations (e.g., ease of separation). Suitable activated carbons include wood PACs, such as NORIT® CA1, NORIT® CA3, DARCO® KB-G, and DARCO® KB-M; wood GACs, such as NORIT® C GRAN; coal PACs, such as NORIT® PAC 200; coal GACs, such as NORIT® GAC 300; and steam activated PACs derived from other carbon sources, such as DARCO® G-60, all of which are commercially available from Cabot Norit Americas, Inc.

In some embodiments, the activated carbon comprises granular activated carbon (GAC). The GAC can have a particle size ranging from 4 mesh to 325 mesh, based on United States Standard Sieve Series. For example, the GAC can have a particle size of 4 mesh or less based on United States Standard Sieve Series, wherein at least 99.5% of the activated carbon is below this top limit (e.g., a particle size of 5 mesh or less, a particle size of 6 mesh or less, a particle size of 7 mesh or less, a particle size of 8 mesh or less, a particle size of 10 mesh or less, a particle size of 12 mesh or less, a particle size of 14 mesh or less, a particle size of 16 mesh or less, a particle size of 18 mesh or less, a particle size of 20 mesh or less, a particle size of 25 mesh or less, a particle size of 30 mesh or less, a particle size of 35 mesh or less, a particle size of 40 mesh or less, a particle size of 45 mesh or less, a particle size of 50 mesh or less, a particle size of 60 mesh or less, a particle size of 70 mesh or less, a particle size of 80 mesh or less, a particle size of 100 mesh or less, a particle size of 120 mesh or less, a particle size of 140 mesh or less, a particle size of 170 mesh or less, a particle size of 200 mesh or less, a particle size of 230 mesh or less, or a particle size of 270 mesh or less). In some embodiments, the GAC can have a minimum particle size of at least 325 mesh based on United States Standard Sieve Series, wherein at least 99.5% of the activated carbon is above this bottom limit (e.g., a minimum particle size of at least 270 mesh, a minimum particle size of at least 230 mesh, a minimum particle size of at least 200 mesh, a minimum particle size of at least 170 mesh, a minimum particle size of at least 140 mesh, a minimum particle size of at least 120 mesh, a minimum particle size of at least 100 mesh, a minimum particle size of at least 80 mesh, a minimum particle size of at least 70 mesh, a minimum particle size of at least 60 mesh, a minimum particle size of at least 50 mesh, a minimum particle size of at least 45 mesh, a minimum particle size of at least 40 mesh, a minimum particle size of at least 35 mesh, a minimum particle size of at least 30 mesh, a minimum particle size of at least 25 mesh, a minimum particle size of at least 20 mesh, a minimum particle size of at least 18 mesh, a minimum particle size of at least 16 mesh, a minimum particle size of at least 14 mesh, a minimum particle size of at least 12 mesh, a minimum particle size of at least 10 mesh, a minimum particle size of at least 8 mesh, a minimum particle size of at least 7 mesh, a minimum particle size of at least 6 mesh, or a minimum particle size of at least 4 mesh).

The GAC can have an average particle size ranging from any of the minimum particle size to any of the maximum particle sizes described above, wherein at least 99.5% of the activated carbon has a particle size within the minimum particle size and the maximum particle sizes. In some embodiments, the GAC can have a nominal mesh size of 4×325 (e.g., a nominal mesh size of 10×20, 12×20, 12×40, 40×80, 80×325, or 10×325 mesh).

The ratio of the volume of micropores in the activated carbon to the volume of mesopores in the activated carbon to the volume of macropores in the activated carbon can be 1.5:1:1.25. In one embodiment, the activated carbon comprises steam activated bituminous coal activated carbon having volume of 0.3 mL/g of micropores, 0.2 mL/g of mesopores, and 0.25 mL/g of macropores.

The ratio of the volume of micropores in the activated carbon to the volume of mesopores in the activated carbon to the volume of macropores in the activated carbon can be 1:5:3. In one embodiment, the activated carbon comprises steam activated lignite coal activated carbon having volume of 0.1 mL/g of micropores, 0.5 mL/g of mesopores, and 0.3 mL/g of macropores.

The ratio of the volume of micropores in the activated carbon to the volume of mesopores in the activated carbon to the volume of macropores in the activated carbon can be 1:2:2. In one embodiment, the activated carbon comprises steam activated peat activated carbon having volume of 0.2 mL/g of micropores, 0.4 mL/g of mesopores, and 0.4 mL/g of macropores.

The ratio of the volume of micropores in the activated carbon to the volume of mesopores in the activated carbon to the volume of macropores in the activated carbon can be 1:3.6:2.2. In one embodiment, the activated carbon comprises steam activated wood activated carbon having volume of 0.25 mL/g of micropores, 0.9 mL/g of mesopores, and 0.55 mL/g of macropores.

The ability of activated carbons to adsorb small and medium sized molecules can be quantitatively evaluated by measuring the methylene blue adsorption level of the activated carbon. In some embodiments, the activated carbon has a methylene blue absorption, measured in g/100 g, of at least 20 g/100 g (e.g., at least 21 g/100 g, at least 22 g/100 g, at least 23 g/100 g, at least 24 g/100 g, at least 25 g/100 g, at least 26 g/100 g, or at least 27 g/100 g). In some embodiments, the activated carbon has a methylene blue absorption of 28 g/100 g or less (e.g., 27 g/100 g or less, 26 g/100 g or less, 25 g/100 g or less, 24 g/100 g or less, 23 g/100 g or less, 22 g/100 g or less, or 21 g/100 g or less).

The activated carbon can have a methylene blue absorption ranging from any of the minimum values described above to any of the maximum values described above. For example, the activated carbon can have a methylene blue absorption ranging from 20 g/100 g to 28 g/100 g (e.g., from 20 g/100 g to 25 g/100 g).

Activated carbons can exhibit varying surface chemistries. As a result of the manufacturing processes used to activate them, activated carbons can be alkaline, neutral, or acidic. In some embodiments, the activated carbon used as a catalyst in the esterification reaction is an acidic (i.e., the pH of a water extract of the activated carbon, as measured using the method described in ASTM D3838-05, is less than 7). In some embodiments, pH of a water extract of the activated carbon used as a catalyst in the esterification reaction, as measured using the method described in ASTM D3838-05, is 8.0 or less (e.g., 7.5 or less, 7.0 or less, 6.5 or less, 6.0 or less, 5.5 or less, 5.0 or less, 4.5 or less, 4.0 or less, 3.5 or less, 3.0 or less, 2.5 or less, or 2.0 or less). In some embodiments, pH of a water extract of the activated carbon used as a catalyst in the esterification reaction, as measured using the method described in ASTM D3838-05, is at least 1.5 (e.g., at least 2.0, at least 2.5, at least 3.0, at least 3.5, at least 4.0, at least 4.5, at least 5.0, at least 5.5, at least 6.0, at least 6.5, at least 7.0, or at least 7.5).

In some embodiments, the rosin ester is flowed through a stationary phase comprising the microporous adsorbent (e.g., activated carbon). The stationary phase can be disposed within any suitable vessel so as to facilitate treatment of the rosin ester with the microporous adsorbent. In some cases, the stationary phase is disposed within a fixed bed reactor. In these embodiments, the rosin ester can be flowed through the fixed bed reactor following esterification. The rosin ester composition can be flowed through the stationary phase under an inert atmosphere, such as a nitrogen atmosphere. Pressure can be applied to facilitate flow of the rosin ester through the stationary phase, with the applied pressure being varied to control flow rate of the rosin ester through the stationary phase. The stationary phase can comprise a single microporous adsorbent or a mixture of two or more microporous adsorbents. In certain embodiments, the stationary phase comprises a blend of two or more activated carbons having different average pore sizes. In some embodiments, the stationary phase comprises an activated carbon in combination with one or more additional components. For example, the stationary phase can further include an additional carbonaceous material (e.g., peat), an additional non-carbonaceous microporous adsorbent (e.g., silica, a zeolite, clay, alumina, or combinations thereof), or combinations thereof.

The contact time of the rosin ester with the microporous adsorbent can be defined by calculation of the empty bed contact time (EBCT). The EBCT of the microporous adsorbent is defined by the formula below

$$EBCT = \frac{( 7.48 \times V )}{Q}$$

wherein EBCT is the empty bed contact time of the microporous adsorbent in minutes; V is the volume of the microporous adsorbent in cubic feet; and Q is the flow rate of the rosin ester through the microporous adsorbent in gallons per minute. In some embodiments, the volume of the microporous adsorbent and the flow rate of the rosin ester through the microporous adsorbent are effective to yield an empty bed contact time of 1.5 hours or more (e.g., 2 hours or more, 2.5 hours or more, 3 hours or more, 4 hours or more, 5 hours or more, 6 hours or more, 8 hours or more, 10 hours or more, 12 hours or more, 18 hours or more, or 24 hours or more).

The rosin ester can be flowed through the microporous adsorbent at a flow rate effective to reduce the neat Gardner color of the rosin ester, as determined according to the method described in ASTM D1544-04 (2010). For example, in some embodiments, the rosin ester is flowed through the microporous adsorbent at a flow rate effective to reduce the neat Gardner color of the rosin ester by at least 10% (e.g., at least 15%, at least 20%, at least 25%, at least 30%, at least 35%, at least 40%, at least 45%, at least 50%, or more). The rosin ester can be flowed through the microporous adsorbent at a flow rate effective to reduce the neat Gardner color of the rosin ester by at least 1 Gardner color unit, as determined according to the method described in ASTM D1544-04 (2010). In certain embodiments, the rosin ester is flowed through the microporous adsorbent at a flow rate effective to reduce the neat Gardner color of the rosin ester by from 1 to 2.5 Gardner color units.

The rosin ester can be flowed through the microporous adsorbent at a flow rate effective to reduce the concentration of sulfur and/or sulfur containing compounds in the rosin ester. The sulfur content of the rosin ester can be measured with an ANTEK® 9000 sulfur analyzer using the standard methods described in ASTM D5453-05. For example, in some embodiments, the rosin ester is flowed through the microporous adsorbent at a flow rate effective to reduce the concentration of sulfur in the rosin ester by at least 10% (e.g., at least 15%, at least 20%, at least 25%, at least 30%, at least 35%, at least 40%, at least 45%, at least 50%, or more). The rosin ester can be flowed through the microporous adsorbent at a flow rate effective to reduce the concentration of sulfur in the rosin ester by at least 50 ppm (e.g., at least 100 ppm, at least 150 ppm, at least 200 ppm, at least 250 ppm, or at least 300 ppm).

Suitable flow rates for the rosin ester through the microporous adsorbent can be selected in view of a number of factors, including the desired properties of the resulting rosin ester (e.g., the desired concentration of sulfur and/or sulfur containing compounds in the rosin ester, the desired Gardner color of the rosin ester, or combinations thereof), the properties of the rosin ester prior to contact with the microporous adsorbent (e.g., the concentration of sulfur and/or sulfur containing compounds in the rosin ester prior to contact with the microporous adsorbent, the Gardner color of the rosin ester prior to contact with the microporous adsorbent, or combinations thereof), the desired empty bed contact time of the microporous adsorbent, the volume of the microporous adsorbent, and combinations thereof. In some embodiments, method can comprise measuring the Gardner color and/or the concentration of sulfur and/or sulfur containing compounds in the rosin ester prior to contact with the microporous adsorbent and/or the Gardner color and/or the concentration of sulfur and/or sulfur containing compounds in the rosin ester following contact with the microporous adsorbent, and adjusting the flow rate of the rosin ester through the microporous adsorbent until the desired reduction in Gardner color, the desired reduction in the concentration of sulfur and/or sulfur containing compounds, or combination thereof is achieved. In some embodiments, the method of making a rosin ester can further comprise hydrogenating the rosin ester to form a hydrogenated rosin ester. The hydrogenation reaction can comprise contacting the rosin ester with a hydrogenation catalyst for a period of time and under suitable conditions to form a hydrogenated rosin ester. Methods of hydrogenating rosin esters are known in the art. Hydrogenation reactions can be carried out using a hydrogenation catalyst, such as a heterogeneous hydrogenation catalyst (e.g., a palladium catalyst, such as Pd supported on carbon (Pd/C), a platinum catalyst, such as PtO₂, a nickel catalyst, such as Raney Nickel (Ra-Ni), a rhodium catalyst, or a ruthenium catalyst). In some cases, the hydrogenation catalyst can be present in an amount ranging from 0.25% to 5% by weight, based on the total weight of the crude rosin ester. The hydrogen source for the hydrogenation can be hydrogen (H₂) or a compound which can generate hydrogen under reaction conditions, such as formic acid, isopropanol, cyclohexene, cyclohexadiene, a diimide, or hydrazine.

The hydrogenation reaction can be performed at an elevated temperature, an elevated pressure, or combinations thereof. For example, the hydrogenation reaction can be performed at a temperature ranging from 150° C. to 300° C. (e.g., from 180° C. to 280° C., from 180° C. to 240° C., from 200° C. to 280° C. or from 220° C. to 260° C.). The hydrogenation reaction can performed at a pressure ranging from 250 to 2000 psi (e.g., from 250 to 1450 psi, from 250 to 650 psi, or from 350 to 550 psi). The hydrogenation can be performed prior to, during, and/or after contacting the rosin ester with a microporous adsorbent. In certain embodiments, the hydrogenation can be performed after contacting the rosin ester with a microporous adsorbent.

Optionally a solvent can be present in the hydrogenation reaction. In certain embodiments, the rosin ester hydrogenated in the hydrogenation reaction comprises less than 25% by weight solvent. In some embodiments, the concentration of esterified rosin acids in the rosin ester hydrogenated in the hydrogenation reaction is 75% or more by weight, based on the total weight of the rosin ester. In some embodiments, the rosin ester hydrogenated in the hydrogenation reaction is substantially free of solvent (e.g., the rosin ester comprises less than 1% by weight solvent, based on the total weight of the rosin ester). In certain embodiments, the rosin ester hydrogenated in the hydrogenation reaction has a viscosity of 1,000 cP or less at 25° C.

To obtain a rosin ester having the desired chemical and physical properties for particular applications, methods of making the rosin esters described herein can optionally further include one or more additional processing steps in addition to the esterification reaction and optionally the hydrogenation reaction. In some embodiments, the rosin to be esterified in the esterification reaction, the rosin ester obtained from the esterification reaction, and/or the hydrogenated rosin ester obtained from the hydrogenation reaction can be further processed, for example, to decrease the PAN number of the rosin, the rosin ester, and/or the hydrogenated rosin ester; to influence the weight ratio of various rosin acids and/or rosin acid esters present in the rosin, the rosin ester, and/or the hydrogenated rosin ester; to influence the hydroxyl number of the resultant rosin ester and/or the hydrogenated rosin ester; to influence the acid number of the resultant rosin ester and/or the hydrogenated rosin ester; or combinations thereof. Suitable additional processing steps are known in the art, and can include additional hydrogenation steps (e.g., pre-hydrogenation), dehydrogenation, disproportionation, dimerization, and fortification. In certain embodiments, rosin is processed using one or more of these methods prior to the esterification reaction to improve the chemical and physical properties of the resultant rosin esters. Where chemically permissible, such methods can also be performed in combination with the esterification reaction, following the esterification reaction but prior to the hydrogenation reaction, following the hydrogenation reaction, or combinations thereof to obtain a rosin ester and/or a hydrogenated rosin ester having the desired chemical and physical properties, as discussed in more detail below.

In certain embodiments, the methods of making rosin esters can further comprise disproportionating the rosin prior to the esterification reaction. Rosin disproportionation converts abietadienoic acid moieties into dehydroabietic acid and dihydroabietic acid moieties. Methods of disproportionation are known in the art, and can involve heating rosin, often in the presence of one or more disproportionation agents. Suitable methods for disproportionating rosin are described in, for example, U.S. Pat. Nos. 3,423,389, 4,302,371, and 4,657,703, all of which are incorporated herein by reference.

A variety of suitable disproportionation agents can be used. Examples of suitable disproportionation agents include thiobisnaphthols, including 2,2′thiobisphenols, 3,3′-thiobisphenols, 4,4′-thiobis(resorcinol) and t,t′-thiobis(pyrogallol), 4,4′-15 thiobis(6-t-butyl-m-cresol) and 4/4′-thiobis(6-t-butyl-o-cresol) thiobisnaphthols, 2,2′-thio-bisphenols, 3,3′-thio-bis phenols; metals, including palladium, nickel, and platinum; iodine or iodides (e.g., iron iodide); sulfides (e.g., iron sulfide); and combinations thereof. In certain embodiments, the rosin is disproportionate using a phenol sulfide type disproportionation agent. Examples of suitable phenol sulfide type disproportionation agents include poly-t-butylphenoldisulfide (commercially available under the trade name ROSINOX® from Arkema, Inc.), 4,4′thiobis(2-t-butyl-5-methylphenol (commercially available under the trade name LOWINOX® TBM-6 from Chemtura), nonylphenol disulfide oligomers (such as those commercially available under the trade name ETHANOX® TM323 from Albemarle Corp.), and amylphenol disulfide polymer (such as those commercially available under the trade name VULTAC® 2 from Sovereign Chemical Co.).

In certain embodiments, the rosin is disproportionated prior to the esterification reaction. In these embodiments, a disproportionated rosin or partly disproportionated rosin can be used as a feedstock for the esterification reaction. In some cases, disproportionation or further disproportionation can be conducted during the esterification reaction. For example, disproportionated or partly disproportionated rosin can be generated in situ and esterified thereafter in a one-pot synthesis procedure to a rosin ester.

Optionally, the rosin, rosin ester, and/or hydrogenated rosin ester can be fortified to improve the chemical and physical properties of the resultant rosin esters. In some embodiments, rosin is fortified prior to the esterification reaction to improve the chemical and physical properties of the resultant rosin esters. Fortification of rosin involves the chemical modification of the conjugated double bond system of rosin acids in the rosin, so as to provide a rosin having a lower PAN number and higher molecular weight than the rosin prior to fortification. A number of suitable chemical modifications and related chemical methods are known in the art. For example, rosins can be fortified by means of a Diels-Alder or Ene addition reaction of a rosin acid with a dienophile, such as an α,β-unsaturated organic acid or the anhydride of such an acid. Examples of suitable dienophiles include maleic acid, fumaric acid, acrylic acid, esters derived from these acids, and maleic anhydride.

Optionally, methods can include one or more process steps to influence the hydroxyl number of the resultant rosin ester, to influence the acid number of the resultant rosin ester; or combinations thereof. If desired, rosin esters can be chemically modified following esterification (e.g., following the esterification reaction but prior to any hydrogenation reaction, or following the hydrogenation reaction) to provide a rosin ester having a low hydroxyl number. This process can involve chemical modification of residual hydroxyl moieties in the rosin ester or hydrogenated rosin ester following esterification using synthetic methods known in the art. For example, the rosin ester or hydrogenated rosin ester can be reacted with an acylating agent (e.g., a carboxylic acid or a derivative thereof, such as an acid anhydride). See, for example, U.S. Pat. No. 4,380,513 to Ruckel. Residual hydroxyl moieties in the rosin ester or hydrogenated rosin ester can also be reacted with an electrophilic reagent, such as an isocyanate, to produce the corresponding carbamate derivative. See, for example, U.S. Pat. No. 4,377,510 to to Ruckel. Other suitable electrophilic reagents which can be used to react residual hydroxyl moieties include alkylating agents (e.g., methylating agents such as dimethylsulphate). If desired, following esterification (e.g., following the esterification reaction but prior to any hydrogenation reaction, or following the hydrogenation reaction), unreacted rosin as well as other volatile components, can be removed from the rosin ester or hydrogenated rosin ester, for example, by steam sparging, sparging by an inert gas such as nitrogen gas, wiped film evaporation, short path evaporation, and vacuum distillation. By stripping excess rosin (i.e., rosin acids) from the rosin ester or hydrogenated rosin ester, the acid number of the resultant rosin ester can be reduced.

Also provided are methods of making rosin esters which can comprise (a) flowing a rosin through a microporous adsorbent (e.g., an activated carbon); and (b) esterifying the rosin with an alcohol to form the rosin ester. The microporous adsorbent can have a surface area ranging from 500 m²/g to 2000 m²/g. In some embodiments, the rosin can be flowed through the microporous adsorbent (e.g., activated carbon) at a temperature ranging from 240° C. to 280° C. to induce disproportionation of the rosin prior to esterification. For example, the rosin can be flowed through the microporous adsorbent (e.g., activated carbon) at a temperature ranging from 240° C. to 280° C. and at a flow rate effective to induce from 5% to 20% disproportionation by weight, based on the total weight of the rosin (e.g., from 6% to 15% disproportion by weight, or from 6% to 10% disproportionation by weight). These methods can further comprise hydrogenating the rosin ester to form a hydrogenated rosin ester, disproportionating the rosin prior to treatment of the rosin with the microporous adsorbent (e.g., activated carbon), i.e., prior to step (a), or combinations thereof.

Also provided are methods of making low-sulfur, non-hydrogenated tall oil rosin esters. Methods of making low-sulfur, non-hydrogenated tall oil rosin esters can comprise (a) flowing a tall oil rosin through a microporous adsorbent (e.g., an activated carbon); and (b) esterifying the tall oil rosin with an alcohol to form the tall oil rosin ester. These methods can further comprise disproportionating the tall oil rosin prior to treatment of the tall oil rosin with the microporous adsorbent (i.e., prior to step (a)). In these methods, the tall oil rosin can be flowed through the microporous adsorbent (e.g., an activated carbon) at a flow rate effective to reduce the concentration of sulfur in the rosin ester by at least 50 ppm (e.g., at least 100 ppm, at least 150 ppm, at least 200 ppm, at least 250 ppm, or at least 300 ppm). These methods can be used to prepare a non-hydrogenated tall oil rosin ester comprising 500 ppm or less of sulfur (e.g., 450 ppm or less of sulfur, 400 ppm or less of sulfur, 350 ppm or less of sulfur, 300 ppm or less of sulfur, 250 ppm or less of sulfur, or 200 ppm or less of sulfur).

The methods provided herein can be used to prepare rosin esters exhibiting improved color (e.g., the rosin ester can have a neat Gardner color of 8.5 or less), improved oxidative stability (e.g., the rosin ester can exhibit an oxidative-induction time at 130° C. of at least 30 minutes), improved color stability (e.g., the rosin ester can exhibit less than a 10% change in neat Gardner color when heated to a temperature of 160° C. for a period of three hours), reduced sulfur content (e.g., the rosin ester can comprise less than 400 ppm sulfur), or combinations thereof.

The rosin ester can have a low PAN number. The PAN number of a rosin ester refers to the weight percentage of abietadienoic acids (in particular palustric, abietic and neoabietic acids) present in the rosin ester, based on the total weight of the rosin ester. The term “PAN number”, as used herein, specifically refers to the sum of the weight percentages of palustric, abietic and neoabietic acid moieties in a rosin ester, as determined according to method described in ASTM D5974-00 (2010). In some embodiments, the rosin ester can have a PAN number, as determined according to the method described in ASTM D5974-00 (2010), of 15.0 or less (e.g., 14.5 or less, 14.0 or less, 13.5 or less, 13.0 or less, 12.5 or less, 12.0 or less, 11.5 or less, 11.0 or less, 10.5 or less, 10.0 or less, 9.5 or less, 9.0 or less, 8.5 or less, 8.0 or less, 7.5 or less, 7.0 or less, 6.5 or less, 6.0 or less, 5.5 or less, 5.0 or less, 4.5 or less, 4.0 or less, 3.5 or less, 3.0 or less, 2.5 or less, 2.0 or less, 1.5 or less, or 1.0 or less).

The rosin ester can comprise at least 70% by weight of an esterified dehydroabietic acid and an esterified dihydroabietic acid, based on the total weight of the rosin ester (e.g., at least 75% by weight of an esterified dehydroabietic acid and an esterified dihydroabietic acid, at least 80% by weight of an esterified dehydroabietic acid and an esterified dihydroabietic acid, at least 85% by weight of an esterified dehydroabietic acid and an esterified dihydroabietic acid, at least 90% by weight of an esterified dehydroabietic acid and an esterified dihydroabietic acid, or at least 95% by weight of an esterified dehydroabietic acid and an esterified dihydroabietic acid).

In certain cases, the rosin ester has not been hydrogenated following esterification. In some embodiments, the weight ratio of esterified dehydroabietic acid to esterified dihydroabietic acid in the rosin ester is 1:0.25 or less (e.g., 1:0.30 or less, 1:0.35 or less, 1:0.40 or less, 1:0.45 or less, 1:0.50 or less, 1:0.55 or less, 1:0.60 or less, 1:0.65 or less, 1:0.70 or less, or 1:0.75 or less). In some embodiments, the weight ratio of esterified dehydroabietic acid to esterified dihydroabietic acid in the rosin ester is at least 1:0.80 (e.g., at least 1:0.75, at least 1:0.70, at least 1:0.65, at least 1:0.60, at least 1:0.55, at least 1:0.50, at least 1:0.45, at least 1:0.40, at least 1:0.35, or at least 1:0.30). The weight ratio of esterified dehydroabietic acid to esterified dihydroabietic acid in the rosin ester can range from any of the minimum values described above to any of the maximum values described above. For example, the weight ratio of esterified dehydroabietic acid to esterified dihydroabietic acid in the rosin ester can range from 1:0.80 to 1:0.25 (e.g., from 1:0.70 to 1:0.35, from 1:0.65 to 1:0.40, or from 1:0.55 to 1:0.40).

In certain cases, the rosin ester is a hydrogenated rosin ester. In some embodiments, the weight ratio of esterified dehydroabietic acid to esterified dihydroabietic acid in the rosin ester is 1.3:1 or less (e.g., 1.25:1 or less, 1.2:1 or less, 1.15:1 or less, 1.1:1 or less, 1.05:1 or less, 1:1 or less, 1:1.05 or less, 1:1.1 or less, 1:1.15 or less, 1:1.2 or less, 1:1.25 or less, 1:1.3 or less, 1:1.35 or less, 1:1.4 or less, 1:1.45 or less, 1:1.5 or less, 1:1.55 or less, 1:1.6 or less, 1:1.65 or less, 1:1.7 or less, 1:1.75 or less, 1:1.8 or less, 1:1.85 or less, 1:1.9 or less, 1:1.95 or less, 1:2 or less, 1:2.05 or less, 1:2.1 or less, 1:2.15 or less, 1:2.2 or less, 1:2.25 or less, 1:2.3 or less, 1:2.35 or less, 1:2.4 or less, 1:2.45 or less, 1:2.5 or less, or 1:2.55 or less). In some embodiments, the weight ratio of esterified dehydroabietic acid to esterified dihydroabietic acid in the rosin ester is at least 1:2.6 (e.g., at least 1:2.55, at least 1:2.5, at least 1:2.45, at least 1:2.4, at least 1:2.35, at least 1:2.3, at least 1:2.25, at least 1:2.2, at least 1:2.15, at least 1:2.1, at least 1:2.05, at least 1:2, at least 1:1.95, at least 1:1.9, at least 1:1.85, at least 1:1.8, at least 1:1.75, at least 1:1.7, at least 1:1.65, at least 1:1.6, at least 1:1.55, at least 1:1.5, at least 1:1.45, at least 1:1.4, at least 1:1.35, at least 1:1.3, at least 1:1.25, at least 1:1.2, at least 1:1.15, at least 1:1. at least 1:1.05, at least 1:1, at least 1.05:1, at least 1.1:1, at least 1.15:1, at least 1.2:1, or at least 1.25:1).

The weight ratio of esterified dehydroabietic acid to esterified dihydroabietic acid in the rosin ester can range from any of the minimum values described above to any of the maximum values described above. For example, the weight ratio of esterified dehydroabietic acid to esterified dihydroabietic acid in the rosin ester can range from 1.3:1 to 1:2.6 (e.g., from 1.3:1 to 1:2.5, from 1.3:1 to 1:1.6, or from 1.2:1 to 1:1.5).

The rosin ester can be derived from any suitable alcohol, include monoalcohols, diols, and other polyols. Examples of suitable alcohols include glycerol, pentaerythritol, dipentaerythritol, ethylene glycol, diethylene glycol, triethylene glycol, sorbitol, neopentylglycol, trimethylolpropane, methanol, ethanol, propanol, butanol, amyl alcohol, 2-ethyl hexanol, diglycerol, tripentaerythritol, C₈-C₁₁ branched or unbranched alkyl alcohols, and C₇-C₁₆ branched or unbranched arylalkylalcohols. In certain embodiments, the rosin ester is derived from a polyhydric alcohol. For example, the polyhydric alcohol can be selected from the group consisting of ethylene glycol, propylene glycol, diethylene glycol, triethylene glycol, tetraethylene glycol, trimethylene glycol, glycerol, trimethylolpropane, trimethylolethane, pentaerythritol, dipentaerythritol, mannitol, and combinations thereof.

The rosin ester can have a weight average molecular weight, as determined using gel permeation chromatography (GPC) as described in ASTM D5296-05, of at least 800 g/mol (e.g., at least 850 g/mol, at least 900 g/mol, at least 950 g/mol, at least 1000 g/mol, at least 1050 g/mol, at least 1100 g/mol, at least 1150 g/mol, at least 1200 g/mol, at least 1250 g/mol, at least 1300 g/mol, at least 1350 g/mol, at least 1400 g/mol, at least 1450 g/mol, at least 1500 g/mol, at least 1550 g/mol, at least 1600 g/mol, at least 1650 g/mol, at least 1700 g/mol, at least 1750 g/mol, at least 1800 g/mol, at least 1850 g/mol, at least 1900 g/mol, or at least 1950 g/mol). The blend of rosin esters can have a weight average molecular weight of 2000 g/mol or less (e.g., 1950 g/mol or less, 1900 g/mol or less, 1850 g/mol or less, 1800 g/mol or less, 1750 g/mol or less, 1700 g/mol or less, 1650 g/mol or less, 1600 g/mol or less, 1550 g/mol or less, 1500 g/mol or less, 1450 g/mol or less, 1400 g/mol or less, 1350 g/mol or less, 1300 g/mol or less, 1250 g/mol or less, 1200 g/mol or less, 1150 g/mol or less, 1100 g/mol or less, 1050 g/mol or less, 1000 g/mol or less, 950 g/mol or less, 900 g/mol or less, or 850 g/mol or less).

The rosin ester can have a weight average molecular weight ranging from any of the minimum values above to any of the maximum values above. For example, the rosin ester can have a weight average molecular weight of from 800 g/mol to 2000 g/mol (e.g., from 900 g/mol to 1600 g/mol, or from 1000 g/mol to 1500 g/mol).

The rosin esters can have an improved Gardner color. In some embodiments, the rosin ester has a neat Gardner color, as determined according to the method described in ASTM D1544-04 (2010), of 8.5 or less (e.g., 8.0 or less, 7.5 or less, 7.0 or less, 6.5 or less, 6.0 or less, 5.5 or less, 5.0 or less, 4.5 or less, 4.0 or less, 3.5 or less, 3.0 or less, 2.5 or less, 2.0 or less, 1.5 or less, 1.0 or less, or 0.5 or less). In some embodiments, the rosin ester is a hydrogenated rosin ester, and the hydrogenated rosin ester has a neat Gardner color, as determined according to the method described in ASTM D1544-04 (2010), of 4.0 or less (e.g., 3.5 or less, 3.0 or less, 2.5 or less, 2.0 or less, 1.5 or less, 1.0 or less, or 0.5 or less).

The rosin esters can exhibit improved color stability. In some embodiments, the rosin ester can exhibit less than a 10% change in neat Gardner color, as determined according to the method described in ASTM D1544-04 (2010), when heated to a temperature of 160° C. for a period of three hours (e.g., less than a 9.5% change in neat Gardner color, less than a 9% change in neat Gardner color, less than a 8.5% change in neat Gardner color, less than a 8% change in neat Gardner color, less than a 7.5% change in neat Gardner color, less than a 7% change in neat Gardner color, less than a 6.5% change in neat Gardner color, less than a 6% change in neat Gardner color, less than a 5.5% change in neat Gardner color, less than a 5% change in neat Gardner color, less than a 4.5% change in neat Gardner color, less than a 4% change in neat Gardner color, less than a 3.5% change in neat Gardner color, less than a 3% change in neat Gardner color, less than a 2.5% change in neat Gardner color, less than a 2% change in neat Gardner color, less than a 1.5% change in neat Gardner color, or less than a 1% change in neat Gardner color. In certain embodiments, the neat Gardner color of the rosin ester, as determined according to the method described in ASTM D1544-04 (2010), remains substantially unchanged (i.e., exhibits less than a 0.5% change in neat Gardner color) when the rosin ester is heated to a temperature of 160° C. for a period of three hours.

The rosin esters can also exhibit improved oxidative stability. For example, in some embodiments, when 1000 ppm or less of an antioxidant is present in combination with the rosin ester, the rosin ester can exhibit an oxidative-induction time at 130° C., as measured using the methods specified in ASTM D5483-05(2010), of at least 10 minutes (e.g., at least 15 minutes, at least 20 minutes, at least 25 minutes, at least 30 minutes, at least 35 minutes, at least 40 minutes, at least 45 minutes, at least 50 minutes, at least 55 minutes, at least 60 minutes, at least 65 minutes, at least 70 minutes, at least 75 minutes, at least 80 minutes, at least 85 minutes, at least 90 minutes, at least 95 minutes, at least 100 minutes, at least 105 minutes, at least 110 minutes, at least 115 minutes, at least 120 minutes, at least 125 minutes, at least 130 minutes, at least 135 minutes, at least 140 minutes, at least 145 minutes, at least 150 minutes, at least 155 minutes, at least 160 minutes, at least 165 minutes, at least 170 minutes, at least 175 minutes, at least 180 minutes, at least 185 minutes, at least 190 minutes, or at least 195 minutes). In certain embodiments, the rosin ester is a hydrogenated rosin ester, and when 1000 ppm or less of an antioxidant is present in combination with the hydrogenated rosin ester, the hydrogenated rosin ester can exhibit an oxidative-induction time at 130° C., as measured using the methods specified in ASTM D5483-05(2010), of at least 75 minutes (e.g., at least 80 minutes, at least 85 minutes, at least 90 minutes, at least 95 minutes, at least 100 minutes, at least 105 minutes, at least 110 minutes, at least 115 minutes, at least 120 minutes, at least 125 minutes, at least 130 minutes, at least 135 minutes, at least 140 minutes, at least 145 minutes, at least 150 minutes, at least 155 minutes, at least 160 minutes, at least 165 minutes, at least 170 minutes, at least 175 minutes, at least 180 minutes, at least 185 minutes, at least 190 minutes, or at least 195 minutes). In some cases, when 1000 ppm or less of an antioxidant is present in combination with the rosin ester or the hydrogenated rosin ester, the rosin ester or the hydrogenated rosin ester can exhibit an oxidative-induction time at 130° C., as measured using the methods specified in ASTM D5483-05(2010), of 250 minutes or less (e.g., 200 minutes or less).

In some embodiments, the rosin ester includes less that 1000 ppm antioxidant (e.g., less than 950 ppm antioxidant, less than 900 ppm antioxidant, less than 850 ppm antioxidant, less than 800 ppm antioxidant, less than 750 ppm antioxidant, less than 700 ppm antioxidant, less than 650 ppm antioxidant, less than 600 ppm antioxidant, less than 550 ppm antioxidant, less than 500 ppm antioxidant, less than 450 ppm antioxidant, less than 400 ppm antioxidant, less than 350 ppm antioxidant, less than 300 ppm antioxidant, less than 250 ppm antioxidant, less than 200 ppm antioxidant, less than 150 ppm antioxidant, less than 100 ppm antioxidant, less than 50 ppm antioxidant, or less than 10 ppm antioxidant).

Optionally, the rosin esters can have a low hydroxyl number. In some embodiments, the rosin ester has a hydroxyl number, as measured using a modified version of the standard method provided in DIN 53240-2 (different solvent tetrahydrofuran was applied), of 5.0 or less (e.g., 4.5 or less, 4.0 or less, 3.5 or less, 3.0 or less, 2.5 or less, 2.0 or less, 1.5 or less, or 1.0 or less). The hydroxyl number is expressed as mg KOH per gram rosin ester sample.

The rosin ester can optionally have a low acid number. In some embodiments, the rosin ester has an acid number, as determined according to the method described in ASTM D465-05 (2010), of 10.0 or less (e.g., 9.5 or less, 9.0 or less, 8.5 or less, 8.0 or less, 7.5 or less, 7.0 or less, 6.5 or less, 6.0 or less, 5.5 or less, 5.0 or less, 4.5 or less, 4.0 or less, 3.5 or less, 3.0 or less, 2.5 or less, 2.0 or less, 1.5 or less, or 1.0 or less). The acid number is expressed as mg KOH per gram rosin ester sample.

The rosin ester can optionally have low sulfur content. In some embodiments, the rosin ester comprises less than 400 ppm sulfur, as measured using the standard methods described in ASTM D5453-05 (e.g., less than 350 ppm sulfur, less than 300 ppm sulfur, less than 250 ppm sulfur, or less than 200 ppm sulfur).

The rosin esters prepared using the methods described herein can be used in a range of applications. For example, the rosin esters can be incorporated into polymeric compositions, for example, as a tackifier. Polymeric compositions can include a rosin ester and a polymer derived from one or more ethylenically-unsaturated monomers. In this context, a polymer derived from an ethylenically-unsaturated monomer includes polymers derived, at least in part, from polymerization of the ethylenically-unsaturated monomer. For example, a polymer derived from an ethylenically-unsaturated monomers can be obtained by, for example, radical polymerization of a monomer mixture comprising the ethylenically-unsaturated monomer. A polymer derived from an ethylenically-unsaturated monomer can be said to contain monomer units obtained by polymerization (e.g., radical polymerization) of the ethylenically-unsaturated monomer. Polymeric compositions can also comprise a rosin ester described herein and a blend of two or more polymers derived from one or more ethylenically-unsaturated monomers. In these cases, the blend of two or more polymers can be, for example, a blend of two or more polymers having different chemical compositions (e.g., a blend of poly(ethylene-co-vinyl acetate) and polyvinyl acetate; or a blend of two poly(ethylene-co-vinyl acetates) derived from different weight percents of ethylene and vinyl acetate monomers).

The polymer can be a homopolymer or a copolymer (e.g., a random copolymer or a block copolymer) derived from one or more ethylenically-unsaturated monomers. In other words, the homopolymer or copolymer can include monomer units of one or more ethylenically-unsaturated monomers. The polymer can be a branched polymer or copolymer. For example, polymer can be a graft copolymer having a polymeric backbone and a plurality of polymeric side chains grafted to the polymeric backbone. In some cases, the polymer can be a graft copolymer having a backbone of a first chemical composition and a plurality of polymeric side chains which are structurally distinct from the polymeric backbone (e.g., having a different chemical composition than the polymeric backbone) grafted to the polymeric backbone.

Examples of suitable ethylenically-unsaturated monomers include (meth)acrylate monomers, vinyl aromatic monomers (e.g., styrene), vinyl esters of a carboxylic acids, (meth)acrylonitriles, vinyl halides, vinyl ethers, (meth)acrylamides and (meth)acrylamide derivatives, ethylenically unsaturated aliphatic monomers (e.g., ethylene, butylene, butadiene), and combinations thereof. As used herein, the term “(meth)acrylate monomer” includes acrylate, methacrylate, diacrylate, and dimethacrylate monomers. Similarly, the term “(meth)acrylonitrile” includes acrylonitrile, methacrylonitrile, etc. and the term “(meth)acrylamide” includes acrylamide, methacrylamide, etc.

Suitable (meth)acrylate monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₁-C₁₂, C₁-C₈, or C₁-C₄ alkanols). Exemplary (meth)acrylate monomers include, but are not limited to, methyl acrylate, methyl (meth)acrylate, ethyl acrylate, ethyl (meth)acrylate, butyl acrylate, butyl (meth)acrylate, isobutyl (meth)acrylate, n-hexyl (meth)acrylate, ethylhexyl (meth)acrylate, n-heptyl (meth)acrylate, ethyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, acetoacetoxyethyl (meth)acrylate, acetoacetoxypropyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-ethylhexyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate and combinations thereof.

Suitable vinyl aromatic compounds include styrene, α- and p-methylstyrene, α-butylstyrene, 4-n-butylstyrene, 4-n-decylstyrene, vinyltoluene, and combinations thereof. Suitable vinyl esters of carboxylic acids include vinyl esters of carboxylic acids comprising up to 20 carbon atoms, such as vinyl laurate, vinyl stearate, vinyl propionate, versatic acid vinyl esters, and combinations thereof. Suitable vinyl halides can include ethylenically unsaturated compounds substituted by chlorine, fluorine or bromine, such as vinyl chloride and vinylidene chloride. Suitable vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 2 to 8 carbon atoms and one olefinic double bond, such as ethylene, as well as hydrocarbons having 4 to 8 carbon atoms and two olefinic double bonds, such as butadiene, isoprene, and chloroprene.

In some embodiments, the polymer derived from one or more ethylenically-unsaturated monomers comprises a copolymer of ethylene and n-butyl acrylate. In some embodiments, the polymer derived from one or more ethylenically-unsaturated monomers comprises a copolymer of styrene and one or more of isoprene and butadiene. In certain embodiments, the polymer derived from one or more ethylenically-unsaturated monomers comprises a metallocene-catalyzed polyolefin. Examples of suitable metallocene-catalyzed polyolefins include metallocene polyethylenes and metallocene polyethylene copolymers, which are commercially available, for example, from Exxon Mobil Corporation (under the trade name EXACT®) and Dow Chemical Company (under the trade name AFFINITY®).

In certain embodiments, the polymer derived from one or more ethylenically-unsaturated monomers comprises a polymer derived from vinyl acetate. Polymers derived from vinyl acetate include polymers derived, at least in part, from polymerization of vinyl acetate monomers. For example, the polymer derived from vinyl acetate can be a homopolymer of vinyl acetate (i.e., polyvinyl acetate; PVA). The polymer derived from vinyl acetate can also be a copolymer of vinyl acetate and one or more additional ethylenically-unsaturated monomers (e.g., poly(ethylene-co-vinyl acetate), EVA). In these embodiments, the polymer derived from vinyl acetate can be derived from varying amounts of vinyl acetate, so as to provide a polymer having the chemical and physical properties suitable for a particular application.

In some embodiments, the rosin ester includes more than one type of rosin ester. For example, the rosin ester can include a mixture of two rosin esters which are derived from the same type of rosin and two different alcohols (e.g., a pentaerythritol ester of tall oil rosin and a glycerol ester of tall oil rosin), a mixture of two rosin esters which are derived from the same alcohol and two different types of rosin (e.g., a pentaerythritol ester of tall oil rosin and a pentaerythritol ester of gum rosin), or a mixture of two rosin esters which are derived from two different alcohols and two different types of rosin (e.g., a pentaerythritol ester of tall oil rosin and a glycerol ester of gum rosin).

In some cases, the polymeric composition can be an adhesive formulation (e.g., hot-melt adhesive formulation), an ink formulation, a coating formulation, a rubber formulation, a sealant formulation, an asphalt formulation, or a pavement marking formulation (e.g., a thermoplastic road marking formulation).

In certain embodiments, the composition is a hot-melt adhesive. In these embodiments, the rosin ester can function as all or a portion of the tackifier component in a traditional hot-melt adhesive formulation. The polymer derived from one or more ethylenically-unsaturated monomers (e.g., a polymer derived from vinyl acetate such as EVA), the rosin ester, and one or more additional components, can be present in amounts effective to provide a hot-melt adhesive having the characteristics required for a particular application. For example, the polymer derived from one or more ethylenically-unsaturated monomers (e.g., a polymer derived from vinyl acetate such as EVA), can be from 10% by weight to 60% by weight of the hot-melt adhesive composition (e.g., from 20% by weight to 60% by weight of the hot-melt adhesive composition, from 25% by weight to 50% by weight of the hot-melt adhesive composition, or from 30% by weight to 40% by weight of the hot-melt adhesive composition). The rosin ester can be from 20% by weight to 50% by weight of the hot-melt adhesive composition (e.g., from 25% by weight to 45% by weight of the hot-melt adhesive composition, or from 30% by weight to 40% by weight of the hot-melt adhesive composition).

The hot-melt adhesive can further include one or more additional components, including additional tackifiers, waxes, stabilizers (e.g., antioxidants and UV stabilizers), plasticizers (e.g., benzoates and phthalates), paraffin oils, nucleating agents, optical brighteners, pigments dyes, glitter, biocides, flame retardants, anti-static agents, anti-slip agents, anti-blocking agents, lubricants, and fillers. In some embodiments, the hot-melt adhesive further comprises a wax. Suitable waxes include paraffin-based waxes and synthetic Fischer-Tropsch waxes. The waxes can be from 10% by weight to 40% by weight of the hot-melt adhesive composition, based on the total weight of the composition (e.g., from 20% by weight to 30% by weight of the hot-melt adhesive composition).

In certain embodiments, the composition is a hot-melt adhesive and the polymer derived from one or more ethylenically-unsaturated monomers is EVA. In certain embodiments, the EVA can be derived from 10% by weight to 40% by weight vinyl acetate, based on the total weight of all of the monomers polymerized to form the EVA (e.g., from 17% by weight to 34% by weight vinyl acetate).

In certain embodiments, the composition is a thermoplastic road marking formulation. The thermoplastic road marking formulation can include from 5% by weight to 25% by weight of a rosin ester, based on the total weight of the thermoplastic road marking formulation (e.g., from 10% by weight to 20% by weight of the thermoplastic road marking formulation). The thermoplastic road marking formulation can further include a polymer derived from one or more ethylenically-unsaturated monomers (e.g., a polymer derived from vinyl acetate such as EVA) which can be, for example, from 0.1% by weight to 1.5% by weight of the thermoplastic road marking formulation. The thermoplastic road marking formulation can further include a pigment (e.g., from 1% by weight to 10% by weight titanium dioxide), and glass beads (e.g., from 30% by weight to 40% by weight), and a filler (e.g., calcium carbonate which can make up the balance of the composition up to 100% by weight). The thermoplastic road marking formulation can further include an oil (e.g., from 1% by weight to 5% by weight percent mineral oil), a wax (e.g., from 1% by weight to 5% by weight percent paraffin-based wax or synthetic Fischer-Tropsch wax), a stabilizer (e.g., from 0.1% by weight to 0.5% by weight stearic acid), and, optionally, additional polymers and/or binders other than the rosin ester described herein.

In some embodiments, by incorporating a rosin ester prepared using the methods described herein into the polymeric composition, the polymeric composition can exhibit improved thermal stability, including improved viscosity stability on aging at elevated temperatures (thermal aging), improved color stability on thermal aging, or combinations thereof.

In some embodiments, the polymeric compositions provided herein exhibit less than a 10% change in viscosity upon incubation at 177° C. for 96 hours, when analyzed using the modified ASTM D4499-07 method described below (e.g., less than a 9% change in viscosity, less than an 8% change in viscosity, less than a 7.5% change in viscosity, less than a 7% change in viscosity, less than a 6% change in viscosity, less than a 5% change in viscosity, less than a 4% change in viscosity, less than a 3% change in viscosity, less than a 2.5% change in viscosity, less than a 2% change in viscosity, or less than a 1% change in viscosity). In some embodiments, the composition exhibits substantially no change in viscosity (i.e., less than a 0.5% change in viscosity) upon incubation at 177° C. for 96 hours.

In some embodiments, the polymeric compositions provided herein exhibit color stability upon thermal aging. In certain cases, the polymeric compositions provided herein exhibit a change of 5 or less Gardner color units when heated to a temperature of 177° C. for a period of 96 hours (e.g., 4.5 or less, 4.0 or less, 3.5 or less, 3.0 or less, 2.5 or less, 2.0 or less, 1.5 or less, 1.0 or less, or 0.5 or less).

The polymeric compositions provided herein can be used in a variety of applications, including as adhesives (e.g., hot-melt adhesives), inks, coatings, rubbers, sealants, asphalt, and thermoplastic road markings and pavement markings. In some embodiments, the compositions are hot-melt adhesives used, for example, in conjunction with papers and packaging (e.g., to adhere surfaces of corrugated fiberboard boxes and paperboard cartons during assembly and/or packaging, to prepare self-adhesive labels, to apply labels to packaging, or in other applications such as bookbinding), in conjunction with non-woven materials (e.g., to adhere nonwoven material with a backsheet during the construction of disposable diapers), in adhesive tapes, in apparel (e.g., in the assembly of footware, or in the assembly of multi-wall and specialty handbags), in electrical and electronic bonding (e.g., to affix parts or wires in electronic devices), in general wood assembly (e.g., in furniture assembly, or in the assembly of doors and mill work), and in other industrial assembly (e.g., in the assembly of appliances). The rosin esters prepared using the methods described herein can also be used in a variety of additional applications, including as a softener and plasticizer in chewing gum bases, as a weighting and clouding agent in beverages (e.g., citrus flavored beverages), as a surfactant, surface activity modulator, or dispersing agent, as an additive in waxes and wax-based polishes, as a modifier in cosmetic formulations (e.g., mascara), and as a curing agent in concrete.

Also provided are compositions comprising a rosin ester described herein and an oil. Exemplary compositions can include 25% by weight to 55% by weight (e.g., 30% by weight to 50% by weight) of a rosin ester described herein and 45% by weight to 75% by weight (e.g., 50% by weight to 70% by weight) of an oil, such as mineral oil or poly-butene oil.

By way of non-limiting illustration, examples of certain embodiments of the present disclosure are included below.

### EXAMPLES

### General Methods

All materials were characterized using the following methods unless otherwise stated. Hydroxyl numbers were determined according to a modified method (different solvent tetrahydrofuran was applied) of DIN 53240-2 entitled “Determination of Hydroxyl Value—Part 2: Method with Catalyst,” which is incorporated herein by reference in its entirety. The rosin ester (dissolved in tetrahydrofuran) was reacted with acetic anhydride in the presence of 4-dimethylaminopyridine (DMAP). Residual acetic anhydride was hydrolyzed and the resulting mixture titrated with an alcoholic solution of potassium hydroxide (0.5 M). The hydroxyl number is expressed as mg KOH per gram rosin ester sample. Acid numbers were determined according to method described in ASTM D465-05 (2010) entitled “Standard Test Methods for Acid Number of Naval Stores Products Including Tall Oil and Other Related Products,” which is incorporated herein by reference in its entirety. The acid number is expressed as mg KOH per gram rosin ester sample. Softening points were determined according to method described in ASTM E28-99 (2009) entitled “Standard Test Methods for Softening Point of Resins Derived from Naval Stores by Ring-and-Ball Apparatus,” which is incorporated herein by reference in its entirety. The Gardner color of all materials was measured according to the Gardner Color scale as specified in ASTM D1544-04 (2010) entitled “Standard Test Method for Color of Transparent Liquids (Gardner Color Scale),” which is incorporated herein by reference in its entirety. Gardner colors were measured using a Dr Lange LICO® 200 colorimeter. Unless otherwise indicated, all Gardner colors were measured using neat samples. Oxidative-induction time was measured according to the standard methods specified in ASTM D5483-05(2010) entitled “Standard Test Method for Oxidation Induction Time of Lubricating Greases by Pressure Differential Scanning calorimetry,” which is incorporated herein by reference in its entirety. Unless otherwise specified, the oxidative-induction time was measured at 130° C. using 550 psi of oxygen. Sulfur content was measured according to the standard methods described in ASTM D5453-05 entitled “Standard Test Method for Determination of Total Sulfur in Light Hydrocarbons, Motor Fuels and Oils by Ultraviolet Fluorescence,” which is incorporated herein by reference in its entirety. Sulfur content was measured using an ANTEK® 9000 sulfur analyzer.

The isomeric composition of the rosin esters, including the PAN number and the ratio of esterified dehydroabietic acid to esterified dihydroabietic acid, was determined according to the methods described in ASTM D5974-00 (2010) entitled “Standard Test Methods for Fatty and Rosin Acids in Tall Oil Fractionation Products by Capillary Gas Chromatography,” which is incorporated herein by reference in its entirety. Specifically, a rosin ester sample (1.00 g) and 10 mL 2N potassium hydroxide (KOH) in ethanol were added to a high pressure microwave reaction vessel. The reaction vessel was sealed and placed into the rotor of a Perkin Elmer MULTIWAYE® 3000 Microwave System. The sample was saponified in the microwave for 30 minutes at 150° C. Upon completion of the microwave-assisted saponification, the reaction mixture was transferred to a separatory funnel, and dilute hydrochloric acid was added to reduce the pH value to less than 4. This converted the rosin soaps in the reaction mixture to rosin acids. The resulting rosin acids were isolated by way of ethyl ether extraction. Upon removal of the ether solvent, the rosin acids were derivatized and analyzed using a gas chromatograph according to ASTM D5974-00 (2010).

Treatment of Rosin Esters with Activated Carbon

Rosin Ester 1 (a rosin ester derived from tall oil rosin and pentaerythritol having a Gardner color (neat) of 5.1, an oxidative-induction time of 2.6 minutes, and a sulfur concentration of 384.4 ppm) was treated with activated carbon adsorbent. Treatment with activated carbon was performed by flowing Rosin Ester 1 through a stationary phase of activated carbon. Specifically, Rosin Ester 1 was passed molten at 220° C. across a fixed carbon bed packed with CALGON® 1240 GAC under a nitrogen atmosphere at an EBCT of 1.5 hours. Resulting Adsorbed Rosin Ester 1 was analyzed without further purification, and exhibited a Gardner color (neat) of 6.2, an oxidative-induction time of 2 minutes, and a sulfur concentration of 400 ppm. These values are likely slight over-estimates, as trace amounts of activated carbon were present in the samples of Adsorbed Rosin Ester 1 which were analyzed.

Adsorbed Rosin Ester 1 was then hydrogenated. 435 g of Adsorbed Rosin Ester 1 was charged to into a flask, and heated to 180° C. under a nitrogen atmosphere. 8.46 g of 5% Pd/C (2.0% catalyst on a dry weight basis) was charged to flask, at which point the flask was sparged with nitrogen to remove moisture. The reaction mixture was charged into a Parr reactor, and heated to 260° C. under a nitrogen atmosphere. Once at temperature, reactor was pressurized with 650 psi hydrogen gas. Pressure was maintained until hydrogenation was complete (2.5 hours). The reaction was considered complete when the addition of hydrogen gas was not necessary to maintain a pressure 650 psi in the Parr reactor. The Parr reactor was then cooled to 190° C., and Hydrogenated Adsorbed Rosin Ester 1 was discharged. Hydrogenated Adsorbed Rosin Ester 1 exhibited a Gardner color (neat) of 2.0, an oxidative-induction time of 44 minutes, and a sulfur concentration of 184 ppm.

For purposes of comparison, Rosin Ester 1 was hydrogenated using the hydrogenation procedure described above without intervening treatment with activated carbon. In this case, the hydrogenation reaction time was 6 hours. Hydrogenated Rosin Ester 1 exhibited a Gardner color (neat) of 2.5, an oxidative-induction time of 46.9 minutes, and a sulfur concentration of 182 ppm.

The isomeric composition of Rosin Ester 1, Hydrogenated Rosin Ester 1, Adsorbed Rosin Ester 1, and Hydrogenated Adsorbed Rosin Ester 1 are included in Table 1. As shown in Table 1, treatment of the rosin ester with activated carbon prior to hydrogenation dramatically reduced hydrogenation reaction time while furnishing a rosin ester having similar properties.

TABLE 1

| | | | | Adsorbed | Hydrogenated |
|---|---|---|---|---|---|
| | | Rosin | Hydrogenated | Rosin | Adsorbed |
| | | Ester 1 | Rosin Ester 1 | Ester 1 | Rosin Ester 1 |
| | Hydrogenation | | 6 | | 2.5 |
| | Reaction Time | | | | |
| | (hours) | | | | |
| Physical | Gardner Color (neat) | 5.1 | 2.5 | 6.2 | 2.0 |
| Properties | Oxidative-Induction | 2.6 | 46.9 | 2.0 | 44.0 |
| | Time (@130° C., time | | | | |
| | of exotherm onset in | | | | |
| | minutes) | | | | |
| | Sulfur Concentration | 384.4 | 182 | 400 | 184 |
| | (ppm) | | | | |
| Isomeric Composition | Abietic Types | 24.9 | 0.0 | 28.9 | 0.1 |
| (weight percent) | Pimaric Types | 13.8 | 0.0 | 14.4 | 2.9 |
| | Saturated Rosin | 0.0 | 6.2 | 0.0 | 9.7 |
| | Acids | | | | |
| | Dehydroabietic | 24.4 | 34.3 | 28.1 | 41.1 |
| | Dihydroabietic | 7.8 | 53.5 | 6.7 | 39.8 |
| | Other abietics | 9.4 | 0.0 | 11.5 | 0.7 |
| | Secodehydroabietic | 0.0 | 0.0 | 0.8 | 0.5 |
| | acid | | | | |
| | Polyunsaturated rosin | 1.8 | 1.4 | 1.6 | 0.3 |
| | acids | | | | |
| | Decarboxylated | 0.0 | 1.6 | 0.0 | 0.0 |
| | roson | | | | |
| | Unidentified rosin | 3.5 | 0.5 | 5.8 | 1.7 |
| | isomers | | | | |
| | Fatty acids, neutrals, | 3.8 | 2.5 | 2.3 | 3.1 |
| | rosin peaks | | | | |
| | Non Eluting | 10.7 | 15.9 | 11.0 | 7.4 |
| | Total Weight % by | 89.3 | 84.1 | 89.0 | 92.6 |
| | GC | | | | |

Three different rosin esters (Rosin Ester 2, a rosin ester derived from tall oil rosin and pentaerythritol having a Gardner color (neat) of 10.4 and a sulfur concentration of 460.5 ppm; Rosin Ester 3, a rosin ester derived from tall oil rosin and pentaerythritol having a Gardner color (neat) of 6.6; and Rosin Ester 4, SYLVALITE® RE 100 L having a Gardner color (neat) of 4.5), were treated with carbon adsorbents. Treatment with activated carbon was performed by flowing the rosin ester through a stationary phase of the activated carbon. Specifically, the rosin ester was passed molten at 220° C. across a fixed carbon bed packed with Activated Carbon A-H (A=CALGON® CAL 1240; B=NORIT® GAC 400; C=NORIT® C GRAN; D=DARCO® 1240; E=MEADWESTVACO® WV-B30; F=CALGON® CAL 1240-TR; G=CARBOCHEM® DC-40; H=NORIT® PK1-3) under a nitrogen atmosphere at an EBCT of 1.5 hours.

Table 2 includes the Gardner color (neat) of Rosin Esters 2-4 following treatment with various activated carbons, as well as the change in Gardner color (neat) upon treatment with activated carbon. As shown in Table 2, treatment with activated carbon reduces the neat Gardner color of the rosin ester by from 0.5 to 1.7 Gardner color units. Treatment with activated carbon also reduced the sulfur concentration of the rosin ester.

TABLE 2
Treatment of Rosin Esters 2-4 with Activated Carbon
Treatment of Rosin Ester 2 with Activated Carbons

| | Gardner Color | Δ Gardner | Sulfur Concentration |
|---|---|---|---|
| Activated Carbon | (neat) | Color | (ppm) |
| A | 8.7 | 1.7 | 326.3 |
| B | 8.7 | 1.7 | 334.9 |
| C | 9.9 | 0.5 | 396 |
| D | 9.1 | 1.3 | 406 |
| E | 9.0 | 1.4 | — |
| F | 9.3 | 1.1 | — |
| G | 8.9 | 1.5 | — |
| H | 8.8 | 1.6 | — |
| | Gardner Color | Δ Gardner | Sulfur Concentration |
| Adsorbent | (neat) | Color | (ppm) |

Treatment of Rosin Ester 3 with Activated Carbon

| | | | |
|---|---|---|---|
| A | 5.5 | 1.1 | — |

Treatment of Rosin Ester 4 with Activated Carbon

| | | | |
|---|---|---|---|
| A | 3.4 | 1.1 | — |

A = CALGON ® CAL 1240;
B = NORIT ® GAC 400;
C = NORIT ® C GRAN;
D = DARCO ® 1240;
E = MEADWESTVACO ® WV-B30;
F = CALGON ® CAL 1240-TR;
G = CARBOCHEM ® DC-40;
H = NORIT ® PK1-3

Treatment of Rosin Esters with Activated Carbon at Varying Temperatures

Rosin Ester 5 (a rosin ester derived from tall oil rosin and pentaerythritol having a Gardner color (neat) of 9.9) was treated with varying carbon adsorbents as described above, except that the temperature was varied from 160° C. to 220° C.

Table 3 includes the Gardner color (neat) of Rosin Ester 5 following treatment with various activated carbons, as well as the change in Gardner color (neat) upon treatment with activated carbon. As shown in Table 3, treatment with activated carbon at higher temperatures results in Gardner color reduction.

TABLE 3
Treatment of Rosin Ester 5 with Activated Carbons at Varying
Temperatures

| | | Gardner Color | Δ |
|---|---|---|---|
| Temperature (° C.) | Activated Carbon | (neat) | Gardner Color |
| 160 | C | 10.6 | 1.1 |
| 180 | C | 8.8 | 1.1 |
| 180 | D | 8.5 | 1.4 |
| 220 | A | 7.4 | 2.5 |

C = NORIT ® C GRAN;
D = DARCO ® 1240;
A = CALGON ® CAL 1240;

Treatment of Rosin Esters with Activated Carbon for Varying Contact Times

Rosin Ester 1 was treated with CALGON® 1240 GAC using the method described above, except that contact time with the carbon adsorbent was varied.

Table 4 includes the change in Gardner color (neat) of Rosin Ester 1 following treatment with activated carbon for 1.5 hours and 4.5 hours. Table 4 also includes the isomeric composition of Rosin Ester 1 before and after treatment with activated carbon. As shown in Table 4, increasing the contact time from 1.5 hours to 4.5 hours does not provide a significant increase in Gardner color reduction.

TABLE 4
Treatment of Rosin Ester 1 with Activated Carbon for Varying Contact Times

| | | Rosin | Adsorbed | Adsorbed |
|---|---|---|---|---|
| | | Ester 1 | Rosin Ester 1 | Rosin Ester 1 |
| | Contact Time (hours) | | 1.5 | 4.5 |
| | Δ Gardner Color | — | 1.1 | 1.2 |
| | (neat) | | | |
| Isomeric Composition | Abietic Types | 24.90 | 18.32 | 20.14 |
| (weight percent) | Pimaric Types | 13.80 | 10.27 | 10.68 |
| | Dehydroabietic | 24.40 | 27.86 | 25.79 |
| | Dihydroabietic | 7.80 | 6.48 | 6.60 |
| | Other abietics | 9.40 | 10.62 | 11.09 |
| | Secodehydroabietic | 0.0 | 0.62 | 0.79 |
| | acid | | | |
| | Polyunsaturated rosin | 1.80 | 2.06 | 2.64 |
| | acids | | | |
| | Unidentified rosin | 3.50 | 6.75 | 3.25 |
| | isomers | | | |
| | Fatty acids, neutrals, | 3.80 | 3.44 | 2.94 |
| | rosin peaks | | | |
| | Non Eluting | 10.60 | 13.57 | 16.08 |
| | Total Weight % by | 89.40 | 86.43 | 83.92 |
| | GC | | | |

Disproportionation of Rosin Esters using Activated Carbon

Rosin Ester 6 (a tall oil rosin ester having a Gardner color (neat) of 9.9, a softening point of 100.3° C., and a sulfur concentration of 405 ppm) was treated with CALGON® 1240 GAC using the method described above, except that the treatment temperature was 240° C. Adsorbed Rosin Ester 6 exhibited a Gardner color (neat) of 7.4, a softening point of 94.1° C., and a sulfur concentration of 350 ppm.

Table 5 also includes the isomeric composition of Rosin Ester 6 before and after treatment with activated carbon at 240° C. As shown in Table 5, treatment of the rosin ester with activated carbon at 240° C. induced disproportionation of the rosin ester, as indicated by an increase in the weight percent of dehydroabietic acid and dihydroabietic acid and a decrease in the weight percent of abietic-type acids in the rosin ester.

TABLE 5
Disproportionation of Rosin Ester 6 using Activated Carbon

| | | Rosin | Adsorbed | |
|---|---|---|---|---|
| | | Ester 6 | Rosin Ester 6 | Δ (%) |
| Physical | Δ Gardner Color | 9.9 | 7.4 | |
| Properties | (neat) | | | |
| | Softening Point (° C.) | 100.3 | 94.1 | |
| | Sulfur Concentration | 405 | 350 | |
| | (ppm) | | | |
| Isomeric | Abietic Types | 31.8 | 23.8 | −8.0 |
| Composition | Pimaric Types | 13.8 | 12.8 | −1.0 |
| (weight | Dehydroabietic | 26.0 | 31.8 | 5.8 |
| percent) | Dihydroabietic | 5.7 | 7.2 | 1.5 |
| | Other abietics | 12.9 | 10.8 | −2.1 |
| | Secodehydroabietic | 0.0 | 0.0 | 0.0 |
| | acid | | | |
| | Polyunsaturated rosin | 1.1 | 1.2 | 0.1 |
| | acids | | | |
| | Unidentified rosin | 5.1 | 7.4 | 2.3 |
| | isomers | | | |
| | Fatty acids, neutrals, | 3.6 | 5.1 | 1.5 |
| | rosin peaks | | | |

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method of making a rosin ester comprising
(a) esterifying a rosin with an alcohol to form a rosin ester; and
(b) flowing the rosin ester through a microporous adsorbent having a surface area of from 500 m²/g to 2000 m²/g.

2. The method of claim 1, wherein the rosin comprises a rosin selected from the group consisting of tall oil rosins, gum rosins, wood rosins, or combinations thereof.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A method of making a rosin ester comprising
(a) esterifying a rosin with an alcohol to form a rosin ester; and
(b) contacting the rosin ester with a microporous adsorbent having a surface area of from 500 m²/g to 2000 m²/g, a volume of micropores ranging from 0.05 mL/g to 0.4 mL/g, a volume of mesopores ranging from 0.1 mL/g to 1.25 mL/g, and a volume of macropores ranging from 0.1 mL/g to 0.7 mL/g.

41. (canceled)

42. A method of making a rosin ester comprising
(a) esterifying a rosin with an alcohol to form a rosin ester; and
(b) flowing the rosin ester through a stationary phase comprising an activated carbon.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)
